(19) United States
(12) Patent Application Publication
(10) Pub. No.: US 2013/0244861 A1
(43) Pub. Date: Sep. 19, 2013

(54) COMPOSITE CATALYTIC MEMBRANE APPLIED TO CATALYTIC ESTERIFICATION AND PREPARATION METHOD THEREOF

(71) Applicants: Jianxin Li, Hedong District (CN); Benqiao He, Hedong District (CN); Wenying Shi, Hedong District (CN); Yu Cheng, Hedong District (CN)

(72) Inventors: Jianxin Li, Hedong District (CN); Benqiao He, Hedong District (CN); Wenying Shi, Hedong District (CN); Yu Cheng, Hedong District (CN)

(73) Assignee: TIANJIN POLYTECHNIC UNIVERSITY, Hedong District, Tianjin (CN)

(21) Appl. No.: 13/883,798

(22) PCT Filed: Mar. 4, 2011
(86) PCT No.: PCT/CN2011/071538

§ 371 Date: May 7, 2013

(51) Int. Cl. B01J 35/06; B01J 27/19; B01J 37/02; B01J 27/053

(52) U.S. Cl. CPC B01J 35/065; B01J 27/053; B01J 27/19; B01J 37/02
USPC 502/4

(57) ABSTRACT

A composite catalytic membrane applied to catalytic esterification and preparation method thereof are provided. The composite catalytic membrane is porous, and includes nonwoven fabric as base membrane and catalytic coating which is formed on the surface of nonwoven fabric and in the pores and gaps between the nonwoven fabric fibers. The catalytic coating uses solid acid as catalyst and polymer or modified sulfonated polymer as membrane-forming material. The membrane is formed by coating or immersion method, and the composite catalytic membrane is obtained by cross-linking after forming. The greenization and high efficiency of catalytic esterification and preparation of biodiesel can be achieved owing to the microporous structure and huge specific surface area of the composite catalytic membrane. The composite catalytic membrane has high mechanical strength, good reproducibility and stability and easily enables continuous repetitive production of catalytic esterification. The process is simple and easy to control and scale-up.

### BACKGROUND

1. Field of the Invention

The present invention relates generally to membrane materials and catalytic technology, and more specifically to a composite catalytic membrane used to catalyze the esterification and its preparation method. This new membrane can be used specifically to catalyze the esterification of the organic acid and the alcohol and to produce the biodiesel. The proposed International Patent Classification number is Int.CI.B01D71/02.

2. Description of Related Art

Organic carboxylic acid ester is an important fine chemical product, commonly used as a solvent or a spice. It can be used in synthetic fragrances, cosmetics, food and feed additives, surfactants, preservative fungicide, plasticizers for rubber and plastics, or raw materials and intermediates in the pharmaceutical industry. The long-chain organic carboxylic acid ester is also used as a bio-diesel alternative to the petroleum diesel. While the esterification is an important way of preparing esters, it is usually completed with the help of a catalyst. The commonly used acid catalysts are a homogeneous type including the sulfuric acid and hydrochloric acid. In spite of the high catalytic efficiency, such homogeneous acid catalysts, however, have a lot of drawbacks, such as equipment corrosion, serious side effects, difficulty in separating, and serious environmental pollution. As a result, the non-homogeneous catalytic methods have increasingly drawn people's attention in recent years. The catalyst used in the heterogeneous catalytic method is typically of a solid type, such as the solid acid (or solid base), the heteropoly acids and their inorganically supported catalysts, and the polymer membrane catalysts. These catalysts can be easily separated from the final products. They also have such advantages as mild reaction conditions, small equipment corrosion, no environment pollution, easy separation, and ideal for automated and continuous production. However, some of the inherent characteristics of the solid catalyst e.g. the solid catalysts are difficult to disperse due to their low specific surface area; they are prone to water absorption resulting in deactivation and lower catalytic efficiency; the solid acid/alkali catalysts are difficult to load and easy to lose, resulting in shorter life and even polluting products. How to improve the efficiency and lifetime of the heterogeneous catalysts remains a key problem still yet to solve.

The membrane catalysis concept was first proposed in the late 60 s of the last century but did not develop until the mid-1980s. The concept is to couple the membrane separation technology with catalysis technology, enabling the dual function of catalysis and membrane separation. The membrane catalytic technology is a new technology used in recent years in the field of heterogeneous catalysis and is a frontier discipline in the field of catalysis. The technology can separately design the membrane material and the catalyst, thus overcoming some of the disadvantages of the non-homogeneous catalysts and improving its catalytic efficiency. The polymer catalytic membrane generally adopts two types of membrane material. First is the polymer molecular chain introduced with strongly acidic groups (such as the —SO₃H groups) which confer the catalytic properties to the polymer membrane; Second is the solid catalyst directly doped with polymer membrane material, which is currently the most effective method in preparing a polymer catalyst membrane. The Journal of Membrane Science on page 123-134 in volume 138 in 1998 reported a hybrid catalyst membrane obtained by simply blending the solution of the polyvinyl alcohol (PVA) and Zr(SO₄)₂. When this hybrid catalyst membrane is coupled with a pervaporation membrane, the catalytic efficiency can be further increased by 50%. However, its catalytic performance decreases rapidly, mainly due to the loss of the solid catalyst. If the cross-linked PVA of a small stereo-configured glutaraldehyde is used, PVA loss would be greatly reduced (approximately ¼ of that of the cross-linked membrane of a larger stereo-configured phosphate).

Chinese Patent CN 1858160A (2006) discloses preparing a fatty acid lower alkyl ester by using a nano-scale solid acid or solid base catalyst. As the catalytic particles are at the nano level, they have a large surface area, exhibiting a high catalytic activity with a conversion rate of 96.17% and a yield going as high as 99%. Even after 8 cycles of repeated use, the conversion rate can still be maintained at 96%. In contrast, when the catalysts with large particles have been reused for 3 cycles, their conversion rate decreases to 89%. Chinese Patent CN101045688 (2007) reported a novel esterification device which, through a porous membrane, adds a lactic acid to a reaction system containing the alcohol and catalyst and then timely removes water from the reaction system through a pervaporation membrane. Under the given set of conditions, the yield of the methyl lactate reaches above 96%. However, that the catalyst is added directly to the reaction system not only leads to difficulties in reusing the catalyst but also product contamination.

In 2005, Applied Catalysis A-General on page 12-20 in volume 296 reported the introduction of sulfonic acid groups directly onto the surface of the microfiltration membranes of porous polyether sulfone. The Ion Exchange Capacity (IEC) of such a membrane material is pretty high (about 2 meq/g), equivalent to each polyether sulfone molecular chain containing 100 sulfonated polystyrene graft segments. Due to the high activity of this membrane material, a study of reaction kinetics has shown that it has a very high reaction rate. Measured data from experiments have demonstrated that the conversion rate at a residence time of 20 s is the same as that of a batch reaction for 11 h. This is because the reaction medium is to penetrate the catalytic membrane, which is different from the concentration gradient of the mass transfer process of the macroporous ion exchange resin. So its apparent activation energy is at least 20% less than that of the ion exchange resin. However, along with the extension of the reaction time, the catalytic activity of the membrane will decline (by 20%). The author attributed it to the loss of sulfonated styrene graft segments (by about 25%). The study has shown that regulating the catalytic membrane structure may further improve its catalytic performance and stability. An effective method of regulation is to configure a porous structure to improve the membrane catalytic performance, which is also a key issue in the study of the catalytic membranes.

While the polymer/solid catalyst hybrid catalytic membrane may be obtained from the hybrid of a polymer with a solid catalyst and may display a high catalytic efficiency and a long life, they are generally of a dense structure. It means that, while the solid catalyst on the surface plays a catalytic role, the catalyst in the membrane itself hardly plays any part. In fact, the membrane of this type has two disadvantages: a small specific surface area and a low catalyst use efficiency.

### SUMMARY OF THE INVENTION

For the deficiencies of the prior art, the present invention intends to solve the technical problem and to provide a composite catalytic membrane and its preparation method for the catalyzed esterification of the organic acid and alcohol as well as for the bio-diesel production. The object of the present invention is to enlarge the specific surface area of the catalyst membrane and thus to improve its catalytic performance while ensuring its high mechanical strength. The composite catalytic membrane of the present invention has shown a high efficiency in catalytic esterification, a high mechanical strength and a high repetition stability. With such membranes, it is easy to realize the continuous process of the catalytic esterification.

The present invention provides a composite membrane for catalytic esterification. The composite membrane is of a porous structure with a nonwoven fabric as its base membrane. On the surface of the nonwoven fabric as well as in the gaps between the fibers is applied with a catalytic coating. The said coating uses solid acid as the catalyst and the polymer or the modified sulfonated polymer as the membrane-forming material.

The said modified sulfonated polymer is obtained from the precursor of the polymer modified by sulfonation. The substitution degree of the sulfonated group is greater than 0 and less than or equal to 50%. The said polymer is at least one of the polyvinyl alcohol, polyethylene-vinyl alcohol, polyvinylidene fluoride, polyacrylonitrile, cellulose acetate, polysulfone, and polyether sulfone.

The said nonwoven fabric is a porous support made of the polyester, polyacrylonitrile, polyvinyl alcohol, polyethylene, polypropylene or polyvinyl chloride fibers.

The said solid acid is at least one of the zirconium sulfate [Zr(SO₄)₂], phosphomolybdic acid (H₃PMo₁₂O₄₀), and titanium sulfate [Ti(SO₄)₂].

The present invention also provides a method for preparing a composite catalytic membrane used to catalyze the esterification reaction. In this method, the nonwoven fabric is used as the base membrane. The polymer or modified sulfonated polymer is dissolved and blended with a solid acid catalyst in the solvent. The solution obtained is used as the membrane casting solution. The membrane is casted using the coating method or the impregnation method. After solidification in the coagulation bath, the membrane is cross-linked to obtain the composite catalytic membrane.

In this method, the said modified sulfonated polymer is derived from a precursor of the polymer which is modified by sulfonation. The degree of substitution of the sulfonated group is greater than 0 and less than or equal to 50%. The said polymer is at least one of the polyvinyl alcohol, polyethylene-vinyl alcohol, polyvinylidene fluoride, polyacrylonitrile, cellulose acetate, polysulfone and polyether sulfone.

In this method, the said nonwoven fabric is a porous support made of polyester, polyacrylonitrile, polyvinyl alcohol, polyethylene, polypropylene or polyvinyl chloride fiber. Preferably, the nonwoven fabric with porosity between 30% and 66% shall be chosen as a support body.

In this method, the said solid acid is at least one of zirconium [Zr(SO₄)₂], phosphomolybdic acid (H₃PMo₁₂O₄₀) and titanium sulfate [Ti(SO₄)₂].

The mass ratio of the solid acid catalyst and the polymer or the modified sulfonated polymer in the said membrane casting solution is (1˜10): 1, preferably (2˜6): 1.

The cross-linking treatment may further improve the structure and property of the membrane. The said cross-linking treatment includes the high-temperature thermal cross-linking and chemical cross-linking.

The said the cross-linking reagent in chemical cross-linking is the mixed solution of the aqueous solution of formaldehyde or glutaraldehyde with the anhydrous ethanol. Generally, for the cross-linking reagent, the volume ratio of the aqueous solution of formaldehyde or glutaraldehyde and the anhydrous ethanol is 1: 15˜30. The mass fraction of the said aqueous solution of formaldehyde or glutaraldehyde is typically at 50%. For cross-linking, the membrane may be soaked in the chemical reagent for 1 h˜3 h. The temperature of the said high temperature thermal cross-linking is 100° C. to 180° C.

The casting solution may also be added with the cross-linking agent so that the resulting composite membrane may be more stable. The said cross-linking agent is the mixed solution of the aqueous solution of formaldehyde or glutaraldehyde with the anhydrous ethanol. Generally, for the cross-linking reagent, the volume ratio of the aqueous solution of formaldehyde or glutaraldehyde and the anhydrous ethanol is 1: 15-30. The mass fraction of the said aqueous solution of formaldehyde or glutaraldehyde is typically at 50%.

Before casting the membrane, the nonwoven fabric may be modified through the base-catalyzed hydrolysis. The purpose of modification ensures a closer bond between the base membrane and the catalytic coating. Using the base-catalyzed hydrolysis method to modify the nonwoven fabric covers the following steps: First, prepare the NaOH solution in ethanol with a concentration of 5 g/L and the aqueous solution of the fixed accelerator with a concentration of 1 g/L. The said fixed accelerator is cetyl trimethyl ammonium bromide or cetyl trimethyl ammonium chloride; second, put the nonwoven fabric into a container. Add the NaOH solution in ethanol and the aqueous solution of the fixed accelerator. The volume ratio of the NaOH solution in ethanol and the aqueous solution of the fixed accelerator is preferably 50:1, Heat the container for 1 h˜3 h in thermostatic water bath and typically select 40° C.˜60° C. Third, soak the nonwoven fabric in ethanol for 1 h˜3 h to free the fiber surface from solution. Then, place the sample in the electric thermostat blast drying oven to dry it.

The coating method means applying the membrane casting solution on the nonwoven fabric through blade coating.

The impregnation method means soaking the non-woven fabric in the casting solution generally for 1 h˜3 h.

The present invention also provides a suitable coagulation bath which is at least one of the water, ethanol, chloroform, glycerin, or acetone. The coagulation time in the coagulation bath is 30 min˜60 min.

The present invention also provides a suitable solvent for dissolving the polymer or modified sulfonated polymer. The solvent is any one of the distilled water, dimethyl sulfoxide, dimethyl acetamide, dimethyl formamide, or N,N-dimethylpyrrolidone.

The composite membrane of the present invention has a fully homogeneous microporous structure and a large specific surface area, which helps make the catalytic esterification and biodiesel production process greener and more efficient. One of the characteristics of the preparation method of the composite membrane of the present invention is to use the non-woven fabric as the support. The micro-structure (such as the molecular chain structure), mesoscopic structure (such as the cross-linking density), and macroscopic structure (such as the porous structure) may be regulated to achieve a controllable preparation of the composite membrane, thereby increasing the stability and catalytic performance of the membrane. The service life of the composite catalytic membrane of the present invention is about 45 h˜70 h. When the membrane-forming material in the catalytic coating is the polymer, the service life is about 45 h˜50 h. When the membrane-forming material in the catalytic coating is the modified sulfonated polymer, the service life is about 50 h˜70 h. The present invention solves the problem of poor catalytic performance, low stability, poor mechanical strength, and complex preparation process of the existing catalytic membranes

Compared with the prior art, the advantages of the composite membrane of the present invention is that: the effective recombination of the polymer with the microporous structure of the nonwoven fabric base membrane gives rise to a composite membrane with a microporous structure and high specific surface area. The nonwoven fabric base membrane increases the catalytic specific surface area, which has greatly improved the catalytic performance. The composite membrane of the present invention has a high efficiency in the catalytic esterification, a high mechanical strength, and a high repeatability and stability. It becomes easy to apply the catalytic esterification process to continuous production. Its preparation process is simple, easy to control and easy to get raw materials of the membrane. The process is easy to be scaled up for industrial production.

### BRIEF DESCRIPTION OF THE DRAWINGS

FIG. 1 to FIG. 4 are the scanning electron microscope (SEM) pictures of the composite membranes of the present invention prepared in different types of coagulation bath in Embodiment 7.

FIG. 1: Coagulation bath with acetone ×100; FIG. 2: Coagulation bath with ethanol ×100; FIG. 3: Coagulation bath with acetone ×1000; FIG. 4: Coagulation bath with ethanol ×1000 (10 wt % SPVA).

### DETAILED DESCRIPTION OF THE PREFERRED EMBODIMENTS

The following examples may help professionals in the art fully understand the present invention but shall not be in any way limit the present invention.

### Example 1

Using the base-catalyzed hydrolysis method to modify the nonwoven fabric. It covers the following steps: Prepare the NaOH solution in ethanol at 5 g/L and the aqueous solution of cetyl trimethyl ammonium bromide at 1 g/L. Place the nonwoven fabric into a three-necked flask. Add 50 mL of NaOH solution in ethanol and 1 mL of fixed promoting agent. Then heat the mixed solution in a thermostatic water bath at 40° C. for 1 h. Take out the nonwoven fabric and soak it in ethanol for 2 h to remove the unreacted reagents. Then place the sample in the electric thermostat blast drying oven to dry for 3 h. Use a mercury porosimeter to measure the specific surface area and porosity of the base membrane. The properties are as follows in Table 1:

TABLE 1
Measured Performance Parameters of Different Base Membranes

| Non-woven fabric | The total porous | Porosity | Base membrane |
|---|---|---|---|
| (Base membrane) | area (m²/g) | (%) | thickness (mm) |
| Polyester | 4.051 | 65.04 | 1.8 |
| Polyacrylonitrile | 3.986 | 60.12 | 1.6 |
| Polyvinyl alcohol | 4.213 | 65.34 | 1.7 |
| Polyethylene | 3.621 | 58.79 | 1.6 |
| Polypropylene | 3.827 | 57.24 | 1.8 |
| PVC | 3.984 | 60.44 | 1.9 |

Dissolve the polyvinyl alcohol esterified with sulfuric acid (with the sulfonation degree at 4%) in the distilled water to prepare a casting solution of 1 wt %. Then add the solid acid zirconium sulfate Zr(SO₄)₂ and mix evenly under stirring. The mass ratio of Zr(SO₄)₂ and sulfonated polyvinyl alcohol is 4:1. After dissolution, add the cross-linking solution (prepared by mixing 50% glutaraldehyde aqueous solution with ethanol at a volume ratio of 1:15) into the solution of polyvinyl alcohol/solid acid. Deaerate the casting solution. The steps of cleaning nonwaven fabric: Cut out a piece from the modified nonwoven fabric. Place it in the anhydrous ethanol and soak for 24 h to remove impurities from the surface of the fabric. Then take it out and dry. The impregnation method of membrane forming: Immerse the nonwoven fabric in the casting solution for 30 min. Ensure full infiltration between the nonwoven fabric and the membrane casting solution. Then take it out and immediately put it into the ethanol coagulation bath. Coagulate for 30 min. Then add the cross-linking solution (the volume ratio of 50% aqueous formaldehyde solution and the anhydrous ethanol is 1:20). Soak and cross-link for 1 h to obtain the porous composite membranes with the base membrane of different materials.

The above obtained composite membrane is used in catalytic esterification experiments. Experiments are carried out in the membrane reactor with an effective area of 44.16 cm². The steps are as follows: Fix the catalytic membrane in the membrane reactor. Add a certain amount of reactants in the reaction kettle and preheat. Add the reactant to membrane reactor from the upper surface of the membrane using a peristaltic pump. Maintain pressure (an experimental pressure of 0.2 MPa) and withdraw the product from the lower surface of the membrane, 0.5 g product for testing. In the membrane reactor, the polyester nonwoven fabric is used as its base membrane of composite membrane, the zirconium sulfate as the solid catalyst. The process conditions are as following: experiment temperature of 65° C., the mass ratio of the oleic acid and methanol at 1:3. The conversion rate of the esterification is 93.4%, determining by acid-base titration. Similarly, at a temperature of 65° C. and with the molar ratio of the acetic acid and the ethanol at 1:3, the conversion rate of the esterification is 75.7%, determining by acid-base titration.

### Example 2

The modification method of the base membrane and the membrane casting solution preparation are the same with those in Embodiment 1. The difference is the surface coating method of membrane formation. Place a clean and dry glass plate on a membrane-scraping platform with prior leveling. Fix the nonwoven fabric onto the scraping blade. Ensure that the nonwoven fabric is fixed flatly without wrinkles. Pour a certain amount of casting solution uniformly on one end of the nonwoven fabric. Scrap the solution with a glass rod into a uniform membrane of a certain thickness and then keep the membrane in the open air for one minute. Then place it in the ethanol coagulation bath. Coagulate for 60 min. Then add the cross-linking solution (prepared by mixing 50% glutaraldehyde aqueous solution with anhydrous ethanol at a volume ratio of 1:30). Soak and cross-link for 2 h to obtain the porous composite membranes. The catalytic test conditions are the same with those in Embodiment 1. Catalytic properties of the composite membranes (with the polyester nonwoven fabric as their base membrane) obtained by different forming methods are as follows in Table 2.

TABLE 2
Impact of Different Membrane Forming Methods on the Catalytic
Esterification Properties of the Composite Catalytic Membrane

| | The ethyl-acetate | |
|---|---|---|
| Membrane forming | conversion rate | Fatty acid-methyl ester |
| method | (%) | conversion rate (%) |
| Impregnation method | 75.70 | 93.42 |
| Coating method | 74.24 | 92.15 |

### Example 3

Preparation of the composite membranes by impregnation method is as described in Embodiment 1. The difference is that the sulfonated polymers (any one of the polyvinyl alcohol, polyethylene-vinyl alcohol, polyvinylidene fluoride, polyacrylonitrile, various celluloses, polysulfone or polyether sulfone polymer with the degree of sulfonation at 4%) are dissolved in the N,N-dimethyl pyrrolidone solvent and thus formulate a casting solution of 5 wt % which produces the sulfonated polymer/solid acid porous composite membrane. At a temperature of 65° C. and with the mass ratio of oleic acid and methanol at 1:3 and the molar ratio of acetic acid and ethanol at 1:3, the catalytic esterification properties of the porous composite catalytic membrane with the polyester nonwoven cloth as its base membrane are as follows in Table 3.

TABLE 3
Impact of Different Sulfonated Polymers
on the Catalytic Esterification Properties

| | Ethyl-acetate | Fatty acid-methyl |
|---|---|---|
| | conversion | ester conversion |
| Sulfonated polymers | rate (%) | rate (%) |
| Sulfated polyvinyl alcohol | 73.19 | 93.42 |
| Polyethylene - vinyl alcohol | 70.68 | 90.42 |
| Sulfonated polyvinylidene fluoride | 71.94 | 91.51 |
| Sulfonated cellulose | 72.38 | 91.95 |
| Sulfonated polysulfone | 75.64 | 94.61 |
| Sulfonated polyethersulfone | 74.32 | 93.79 |

### Example 4

Dissolve the sulfonated polyether sulfone (with the sulfonation degree at 50%) in the dimethylacetamide solvent and formulate the casting solution respectively at 1 wt %, 5 wt % and 10 wt %. The mass ratio of Zr(SO₄)₂ and sulfonated polyether sulfone is 10:1. Preparation of the composite membranes by impregnation method are as described in Embodiment 1. The difference is the thermal cross-linking after 60 min of coagulation. Thermal cross-linking is to dry the composite membrane in vacuum at 120° C. for 1 h. The test conditions of the catalytic esterification of the composite catalytic membrane are as described in Embodiment 1. The catalytic esterification properties of the porous composite membranes with the nonwoven fabric as their base membrane obtained from casting solutions at different concentrations are shown in Table 4.

TABLE 4
Catalytic Esterification Properties of the Composite Membranes
Obtained from Casting Solutions at Different Concentrations

| Casting solution | Base | Ethyl-acetate | Fatty acid-methyl |
|---|---|---|---|
| concentration | membrane | conversion | ester conversion |
| (wt %) | porosity (%) | rate (%) | rate (%) |
| 1 | 20.46 | 73.19 | 90.21 |
| 5 | 44.87 | 74.68 | 93.22 |
| 10 | 60.34 | 75.94 | 93.51 |

### Example 5

Preparation of the composite membranes by the scraping method is as described in Embodiment 1. The difference is that the solid acid is one of the zirconium sulfate Zr(SO₄)₂, phosphomolybdic acid (H₃PMo₁₂O₄₀), or titanium sulfate (Ti(SO₄)₂). The mass ratio of the solid acid and the sulfonated polysulfone (with the sulfonation degree at 30%) is 1:1. Conduct thermal cross-linking after 60 min of coagulation. Thermal cross-linking here is to dry the composite membrane in vacuum at 150° C. for 5 h. The test conditions of the catalytic esterification of the composite catalytic membrane are as described in Embodiment 1. The catalytic esterification conversion rates in the porous composite membranes (using the polyethylene nonwoven fabric as its base membrane) containing different solid acids are shown in Table 5.

TABLE 5
Catalytic Esterification Properties of the Porous Composite
Membranes Containing Different Solid Acids

| | Ethyl-acetate | Fatty acid-methyl ester conversion |
|---|---|---|
| Solid acid | conversion rate (%) | rate (%) |
| Zr(SO₄)₂ | 73.19 | 93.42 |
| H₃PMo₁₂O₄₀ | 70.68 | 90.42 |
| Ti(SO₄)₂ | 71.94 | 91.51 |

### Example 6

Preparation of the composite membranes by the impregnation method is as described in Embodiment 1. The difference is that the mass ratio of Zr(SO₄)₂ and the sulfonated polyvinyl alcohol is 6:1, 5:1, 4:1, 3:1 and 2:1. The test conditions of the catalytic esterification of the composite catalytic membrane are as described in Embodiment 1. The catalytic properties of the porous composite membranes (using the polyethylene nonwoven fabric as its base membrane) containing Zr(SO₄)₂ and the sulfonated polyvinyl alcohol at different mass ratios are shown in Table 6.

TABLE 6
Catalytic Properties of the Composite Membranes [symbol]
Containing Zr(SO₄)₂ and the Sulfated Polyvinyl
Alcohol at Different Mass Ratios

| Mass ratio of Zr(SO₄)₂ | Ethyl-acetate | Fatty acid-methyl |
|---|---|---|
| and the sulfated | conversion | ester conversion |
| polyvinyl alcohol | rate (%) | rate (%) |
| 6.1 | 70.92. | 90.42 |
| 5.1 | 73.25 | 91.86 |
| 4.1 | 75.94 | 93.51 |
| 3.1. | 76.02 | 93.38 |
| 2.1 | 76.11 | 93.57 |

### Example 7

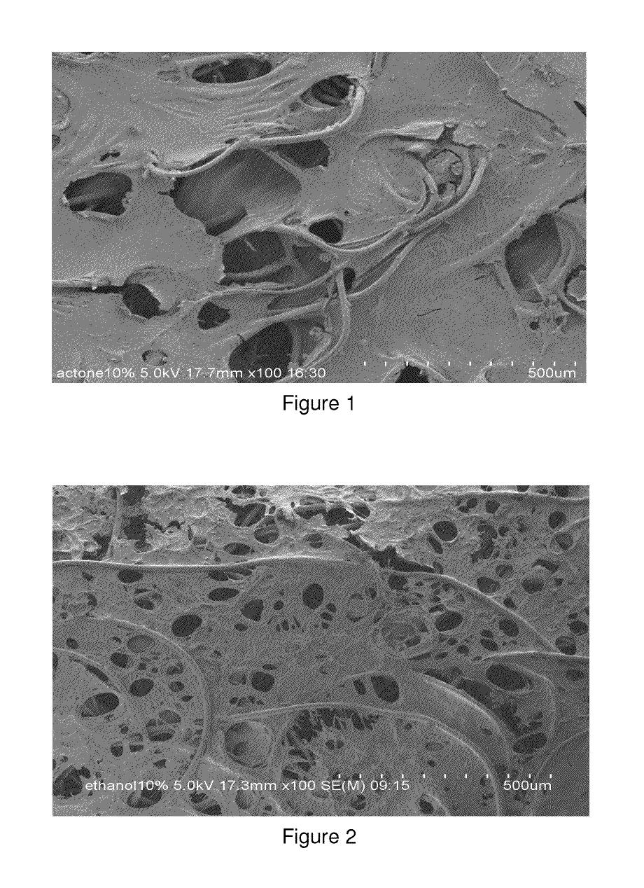

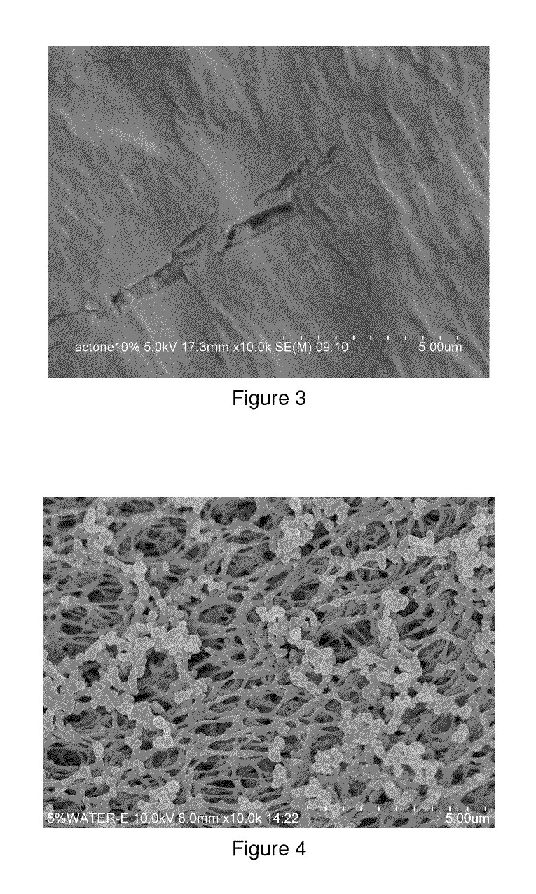

Preparation of the composite membranes by the impregnation method is as described in Embodiment 1. The difference is to use the acetone and ethanol coagulation bath. After coagulation for 30 min, start cross-linking for 3 h. See FIG. 1-FIG. 4 for the membrane structure. As can be seen from FIG. 1-FIG. 4. The resultant composite membrane is a porous membrane structure, with a catalytic coating on the surface of the base membrane as well as in the gaps between the nonwoven fabric fibers with the fibers within the nonwoven fabric. For the polymer membranes between the fibers of the nonwoven fabric, those formed in the acetone coagulation bath are a dense layer, while those in the ethanol coagulation bath are of a honeycomb pore structure. The test conditions of the catalytic esterification of the composite catalytic membrane are as described in Embodiment 1. The catalytic properties of the porous composite membranes (using the polyester nonwoven fabric as its base membrane) with different coagulation baths are shown in Table 7.

TABLE 7
Catalytic Properties of the Composite Membranes
with Different Coagulation Baths

| | Ethyl-acetate conversion | Fatty acid-methyl ester |
|---|---|---|
| Coagulation bath | rate (%) | conversion rate (%) |
| Acetone | 71.32 | 90.15 |
| Ethanol | 75.68 | 93.42 |
| Chloroform | 71.98 | 90.32 |
| Glycerol | 72.69 | 91.46 |

### Example 8

Preparation of the composite membranes by the scraping method is as described in Embodiment 1. The difference is that the sulfonated polyvinyl alcohol is dissolved respectively in the distilled water, dimethyl sulfoxide, dimethylacetamide, dimethylformamide, and N,N-dimethylpyrrolidone to obtain a casting solution of 10 wt %. The test conditions of the catalytic esterification of the composite catalytic membrane are as described in Embodiment 1. The catalytic properties of the porous composite membranes (using the PVC nonwoven fabric as their base membrane) with different solvents are shown in Table 8.

TABLE 8
Catalytic Properties of the Composite
Membranes with Different Solvents

| | Ethyl-acetate | Fatty acid-methyl ester |
|---|---|---|
| Solvent | conversion rate (%) | conversion rate (%) |
| Distilled water | 75.68 | 93.42 |
| Dimethyl sulfoxide | 74.21 | 92.15 |
| Dimethylacetamide | 73.56 | 91.75 |
| Dimethylformamide | 73.24 | 90.43 |
| N,N-methylpyrrolidone | 72.15 | 90.04 |

### Example 9

Preparation of the composite membranes by the scraping method is as described in Embodiment 1. The difference is to conduct thermal cross-linking after 30 min of coagulation. Thermal cross-linking here is to dry the composite membrane respectively at 100, 120, 150, 180° C. in vacuum for 3 h. The test conditions of the catalytic esterification of the composite catalytic membrane are as described in Embodiment 1. The catalytic properties of the porous composite membranes (using the polyester nonwoven fabric as their base membrane) at different temperatures are shown in Table 9.

TABLE 9
Catalytic Properties of the Composite Membranes
at Different Cross-linking Temperatures

| Cross-linking | Ethyl-acetate conversion | Fatty acid-methyl ester |
|---|---|---|
| temperature (° C.) | rate (%) | conversion rate (%) |
| 100 | 73.68 | 91.18 |
| 120 | 74.21 | 92.25 |
| 150 | 75.56 | 93.73 |
| 180 | 74.24 | 92.97 |

The service life of the composite membranes prepared in Embodiment 1-9 is 50 h˜70 h.

### Example 10

Preparation of the composite membranes by the impregnation method is as described in Embodiment 1. The difference is that the polymer is not sulfonated and is one of the polyvinyl alcohol, polyethylene-vinyl alcohol, polyvinylidene fluoride, polyacrylonitrile, various celluloses, polysulfone or polyether sulfone polymers at a sulfonation degree of 4%. Dissolve the polymer in the N,N-dimethyl pyrrolidone solvent and obtain the 5 wt % casting solution which produces the corresponding polymer/solid acid (the zirconium sulfate) porous composite catalyst membrane. At the temperature of 65° C., and with the mass ratio of oleic acid and methanol at 1:3 and the molar ratio of the acetic acid and ethanol at 1:3, the catalytic esterification properties of the porous composite catalytic membrane (using the polyester nonwoven fabric as its base membrane) are shown in Table 10.

TABLE 10
Impact of Different Polymers on Catalytic Esterification Properties

| | Ethyl-acetate | Fatty acid-methyl ester |
|---|---|---|
| Sulfonated polymer | conversion rate (%) | conversion rate (%) |
| Polyvinyl alcohol | 68.12 | 90.56 |
| Polyethylene - vinyl | 68.54 | 90.25 |
| alcohol | | |
| Polyvinylidene fluoride | 69.32 | 90.87 |
| Cellulose | 69.38 | 90.05 |
| Polysulfone | 70.22 | 90.12 |
| Polyethersulfone | 69.45 | 91.79 |

The service life of the porous composite membrane prepared in the present embodiment is 45 h˜50 h.

The composite membranes prepared in the above-described embodiments are porous composite catalytic type with the nonwoven fabric as their base membrane and a catalytic coating on the surface of the nonwoven fabric as well as in the gap between the non-woven fibers. The said catalytic coating uses solid acid as the catalyst and takes polymer or modified sulfonated polymer as the membrane-forming material.

What is described above is only a preferred specific embodiment of the present invention. The scope of protection of the present invention is not limited thereto. All changes or replacements within the technical scope disclosed in the present invention that may be easily formulated by any technical personnel skilled in the art should be covered within the scope of protection of the present invention. Accordingly, the scope of protection of the present invention shall be the scope of protection described in the Claims.

1. A composite catalytic film for catalyzing esterification, wherein the film comprises a porous structure with nonwoven fabric as a base membrane and with a catalytic coating on a surface of the fabric as well as in gaps between the fibers, and wherein said coating uses a solid acid as a catalyst and a modified sulfonated polymer as a film-forming material.

2. The composite catalytic film for catalyzing esterification according to claim 1, wherein said modified sulfonated polymer is derived from a precursor which is modified by sulfonation wherein a degree of substitution of the sulfonated group is greater than 0 and less than or equal to 50%, and wherein said polymer is at least one of polyvinyl alcohol, polyethylene-vinyl alcohol, polyvinylidene fluoride, polyacrylonitrile, cellulose acetate, polysulfone and polyether sulfone.

3. The composite catalytic film for catalyzing esterification according to claim 1, wherein said nonwoven fabric is a porous support made of polyester, polyacrylonitrile, polyvinyl alcohol, polyethylene, polypropylene or polyvinyl chloride fiber.

4. The composite catalytic film for catalyzing esterification according to claim 1, wherein said solid acid is at least one of sulfuric acid, zirconium [Zr(SO₄)₂], phosphomolybdic acid [H₃PMo₁₂O₄₀] and titanium sulfate [Ti(SO₄)₂].

5. A method to prepare a composite catalytic film for catalyzing esterification, wherein the method comprises:
obtaining a nonwoven fabric as a base film;
dissolving and blending a modified sulfonated polymer with a solid acid catalysts in a solvent to obtain a membrane casting solution;
casting the membrane casting solution onto a surface of the base film using a coating method or an impregnation method;
after solidification in a coagulation bath, the membrane is cross-linked,
wherein before casting, the nonwoven fabric is modified by an alkaline-catalyzed hydrolysis method.

6. The method according to claim 5, wherein said nonwoven fabric is a porous support made of polyester, polyacrylonitrile, polyvinyl alcohol, polyethylene, polypropylene or polyvinyl chloride fiber.

7. The method according to claim 5, wherein said modified sulfonated polymer is derived from a precursor of the polymer which is modified by sulfonation wherein a degree of substitution of sulfonated group is greater than 0 and less than or equal to 50%, and wherein said polymer is at least one of polyvinyl alcohol, polyethylene-vinyl alcohol, polyvinylidene fluoride, polyacrylonitrile, cellulose acetate, polysulfone and polyether sulfone.

8. The method according to claim 5, wherein said solid acid is at least one of sulfuric acid, zirconium [Zr(SO₄)₂], phosphomolybdic acid [H₃PMo₁₂O₄₀] and titanium sulfate [Ti(SO₄)₂].

9. The method according to claim 5, wherein a mass ratio of the solid acid catalyst and the modified sulfonated polymer in the membrane casting solution is 1˜10:1.

10. The method according to claim 5, wherein a crosslinking agent is added to the membrane casting solution.

11. The method according to claim 5, wherein said cross-linking treatment includes high temperature thermal cross-linking and chemical cross-linking, wherein the chemical crosslinking uses as a cross-linking reagent a mixed solution of an aqueous solution of formaldehyde or glutaraldehyde with anhydrous ethanol, wherein temperature of said high temperature thermal crosslinking is 100° C. to 180° C.

12. The method according to claim 5, wherein the coagulation bath is at least one of water, ethanol, chloroform, glycerin and acetone and wherein said solvent of the modified sulfonated polymer is one of distilled water, dimethyl sulfoxide, dimethyl acetamide, dimethyl formamide and N,N-dimethyl pyrrolidone.
